(19) United States
(12) Patent Application Publication
(10) Pub. No.: US 2020/0220291 A1
(43) Pub. Date: Jul. 9, 2020

(54) TERMINAL

(71) Applicant: LOTES CO., LTD., Keelung (TW)

(72) Inventors: Chien Chih Ho, Keelung (TW); Zuo Feng Jin, Keelung (TW)

(21) Appl. No.: 16/716,651

(22) Filed: Dec. 17, 2019

(30) Foreign Application Priority Data
Jan. 8, 2019 (CN) 201910014252.2

(51) Int. Cl. H01R 13/24

(52) U.S. Cl. CPC H01R 13/2457; H01R 13/245

(57) ABSTRACT

A terminal includes a base, a first elastic arm and a second elastic arm formed side by side by extending upward from an upper end of the base, and a protruding portion. The first elastic arm has a mating portion, and the second elastic arm has a contact portion. The protruding portion protrudes and extends from a first side of the first elastic arm, and the first side of the first elastic arm is adjacent to the second elastic arm. A lower surface of the protruding portion has a contact surface overlapping with the contact portion in a vertical direction, such that the contact portion upward abuts the contact surface. When the chip module presses downward on the terminal, the contact portion can move on the contact surface, such that the chip module does not need to press downward on the contact portion with a relatively large pressure.

### CROSS-REFERENCE TO RELATED PATENT APPLICATION

This non-provisional application claims priority to and the benefit of, pursuant to 35 U.S.C. § 119(a), patent application Serial No. CN201910014252.2 filed in China on Jan. 8, 2019. The disclosure of the above application is incorporated herein in their entireties by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a terminal, and in particular to a terminal that is in vertical compression contact with a chip module.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

To meet the requirements of high-frequency signal transmission of a chip module nowadays, a land grid array (LGA) terminal is generally designed to have multiple elastic arms, forming multiple transmission paths to reduce impedance of the terminal. The Chinese Patent No. CN201721184115.6 discloses a terminal, which is used to be electrically connected to a chip module. The terminal includes: a base, an elastic arm formed by bending and extending upward from the base, and a through groove running through the elastic arm in a vertical direction, such that the elastic arm forms two branches at two sides of the through groove, thereby forming two conductive paths in parallel and respectively passing through the two branches between the chip module and a circuit board to improve high-frequency performance thereof. However, since one end of each of the two branches is connected to the base, the other opposite ends of the two branches are connected together by a beam, and a contact portion bends upward and extends from the beam to contact the chip module, when the chip module presses downward on the contact portion, the two branches can only deform altogether and bind to each other. Therefore, the chip module needs to press downward on the terminal with a relatively large pressure.

Therefore, a heretofore unaddressed need to design a new terminal exists in the art to address the aforementioned deficiencies and inadequacies.

### SUMMARY

The present invention is directed to a terminal in which impedance is reduced and that does not need to be pressed downward by the chip module with a relatively large pressure.

To achieve the foregoing objective, the present invention adopts the following technical solutions:

A terminal includes: a base; a first elastic arm and a second elastic arm formed side by side by extending upward from an upper end of the base, wherein the first elastic arm has a mating portion, and the second elastic arm has a contact portion; and a protruding portion, protruding and extending from a first side of the first elastic arm, wherein the first side of the first elastic arm is adjacent to the second elastic arm, and a lower surface of the protruding portion has a contact surface overlapping with the contact portion in a vertical direction, such that the contact portion upward abuts the contact surface.

In certain embodiments, the protruding portion has a cutting surface, a length of the first elastic arm from the cutting surface to the upper end of the base is greater than or equal to a length of the second elastic arm, and the second elastic arm is connected to the cutting surface before being formed and is cut off from the cutting surface after being formed.

In certain embodiments, a first torn surface is provided on the first side of the first elastic arm adjacent to the second elastic arm, and one of two sides of the second elastic arm is formed by tearing from the first torn surface.

In certain embodiments, a third elastic arm extends upward from the base to the protruding portion, the second elastic arm is located between the first elastic arm and the third elastic arm, a second torn surface is provided on one side of the third elastic arm adjacent to the second elastic arm, the other of the two sides of the second elastic arm is formed by tearing from the second torn surface, and the first elastic arm and the third elastic arm are provided in parallel.

In certain embodiments, a strip connecting portion is formed by extending from the base and is configured to be connected to a strip, the strip connecting portion is located at a second side of the first elastic arm, and the second side of the first elastic arm is located away from the second elastic arm.

In certain embodiments, the first elastic arm has a connecting portion connected to the upper end of the base, the connecting portion and the protruding portion are located at two opposite sides of the base, the second elastic arm has an extending portion connected to the upper end of the base, the extending portion and the contact portion are located at the two opposite sides of the base, and the connecting portion and the extending portion are located at a same side of the base.

In certain embodiments, the contact portion is flat plate shaped, and the contact surface is an arc surface.

A terminal includes: a flat plate portion; a first elastic arm, formed by bending and extending upward from an upper end of the flat plate portion, wherein a top portion of the first elastic arm has a mating portion, one side of the first elastic arm is provided with a torn surface, a protruding portion is formed by laterally extending from the torn surface, the protruding portion has a cutting surface connected to the torn surface, and a lower surface of the protruding portion has a contact surface; and a second elastic arm, formed by bending and extending upward from the upper end of the flat plate portion, wherein a tail end of the second elastic arm is cut off from the cutting surface during forming, one of two sides of the second elastic arm is formed by tearing from the torn surface, and the second elastic arm has a contact portion overlapping with the contact surface in a vertical direction, such that the contact portion upward abuts the contact surface.

In certain embodiments, a third elastic arm extends upward from the flat plate portion to the protruding portion, the second elastic arm is located between the first elastic arm and the third elastic arm, the other of the two sides of the second elastic arm is formed by tearing from the third elastic arm, such that a width of the second elastic arm is equal to a gap width between the first elastic arm and the third elastic arm.

In certain embodiments, the first elastic arm has a connecting portion connected to the upper end of the flat plate portion, the connecting portion and the protruding portion are located at two opposite sides of the flat plate portion, the second elastic arm has an extending portion connected to the upper end of the flat plate portion, the extending portion and the contact portion are located at the two opposite sides of the flat plate portion, and the connecting portion and the extending portion are located at a same side of the flat plate portion.

Compared with the related art, the terminal according to certain embodiments of the present invention has the following beneficial effects.

The first elastic arm and the second elastic arm are formed side by side by extending upward from the upper end of the base, such that a length of the terminal is reduced. In addition, a first conductive path sequentially passing through the chip module, the mating portion, the first elastic arm, the base, and a circuit board and a second conductive path sequentially passing through the chip module, the mating portion, the second elastic arm, the base, and the circuit board are formed between the chip module and the circuit board, and the first conductive path and the second conductive path are in parallel to each other, thereby reducing impedance during telecommunication transmission between the chip module and the circuit board. Moreover, the second elastic arm upward abuts the first elastic arm. When the chip module presses downward on the terminal, the contact portion can move on the contact surface, such that the chip module does not need to press downward on the mating portion with a relatively large pressure.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic perspective view of a terminal before being formed according to a first embodiment of the present invention.

FIG. 2 is a schematic perspective view of the terminal in FIG. 1 after being formed.

FIG. 3 is a front view of FIG. 2.

FIG. 4 is a sectional view of FIG. 3 along the A-A direction.

FIG. 5 is a top view of FIG. 2.

FIG. 6 is a schematic perspective view of a terminal before being formed according to a second embodiment of the present invention.

FIG. 7 is a schematic perspective view of the terminal in FIG. 6 being connected to a strip after being formed.

FIG. 8 is a schematic perspective view of the terminal according to the second embodiment of the present invention.

FIG. 9 is a top view of FIG. 8.

FIG. 10 is a sectional view of FIG. 9 along the B-B direction.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

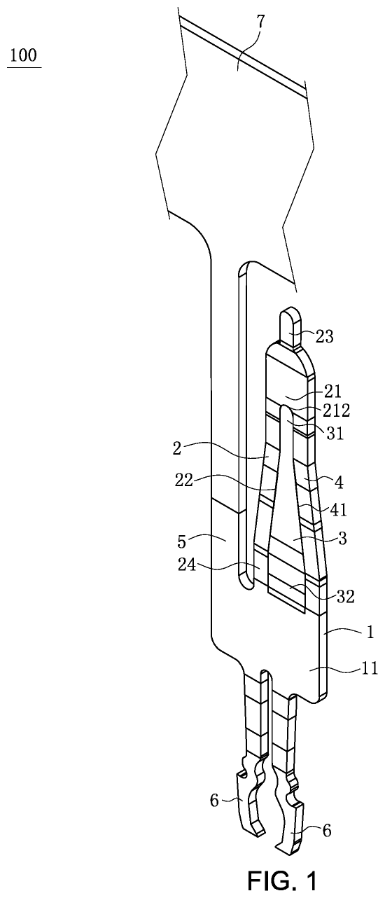

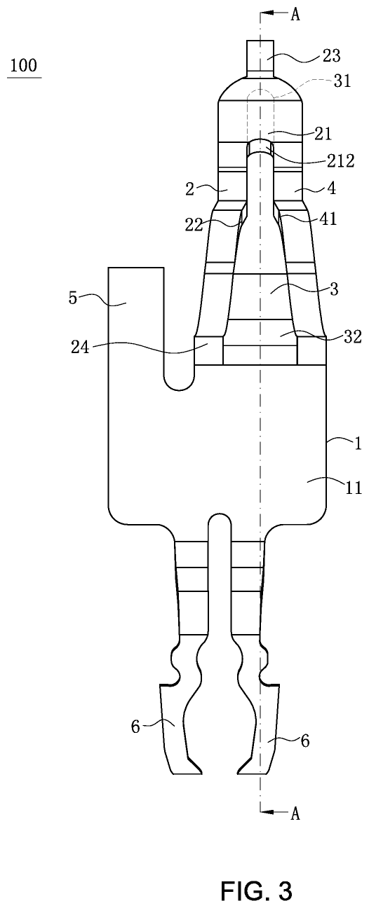

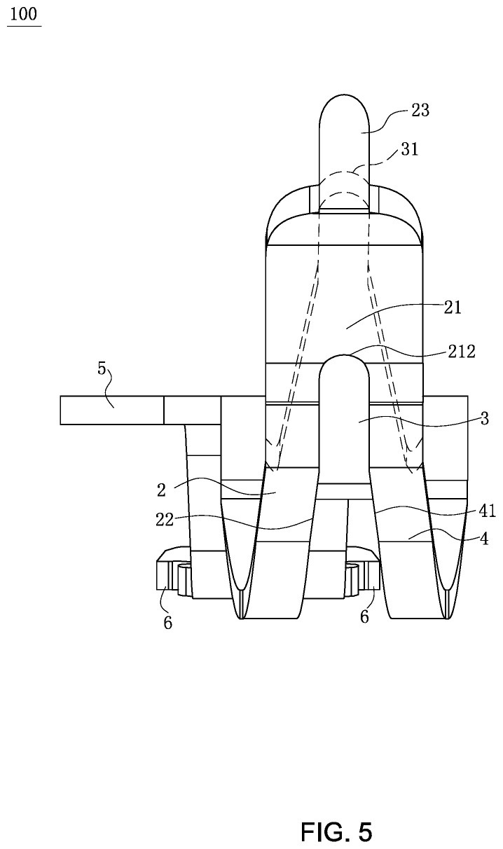

The description will be made as to the embodiments of the present invention in conjunction with the accompanying drawings in FIGS. 1-10. In accordance with the purposes of this invention, as embodied and broadly described herein, this invention, in one aspect, relates to a terminal.

FIG. 1 to FIG. 5 show a terminal 100 according to a first embodiment of the present invention, which is used to electrically connect a chip module (not shown) and a circuit board (not shown). The terminal 100 is formed by stamping a metal plate. Each terminal 100 includes a base 1 that is vertical flat plate shaped, and the base 1 has a vertical plain surface 11. A first elastic arm 2, a second elastic arm 3, and a third elastic arm 4 are formed side by side by bending and extending upward from an upper end of the base 1, and the second elastic arm 3 is located between the first elastic arm 2 and the third elastic arm 4. The first elastic arm 2 has a first side and a second side, where the first side of the first elastic arm 2 is adjacent to the second elastic arm 3, and the second side of the first elastic arm 2 is located away from the second elastic arm 3. A strip connecting portion 5 is formed by vertically extending upward from the base 1 to be connected to a strip 7, and the strip connecting portion 5 is located at the second side of the first elastic arm 2. A pair of clamping portions 6 are formed by bending and extending downward from a lower end of the base 1 to jointly clamp a solder ball (not shown), which is used to be soldered to the circuit board.

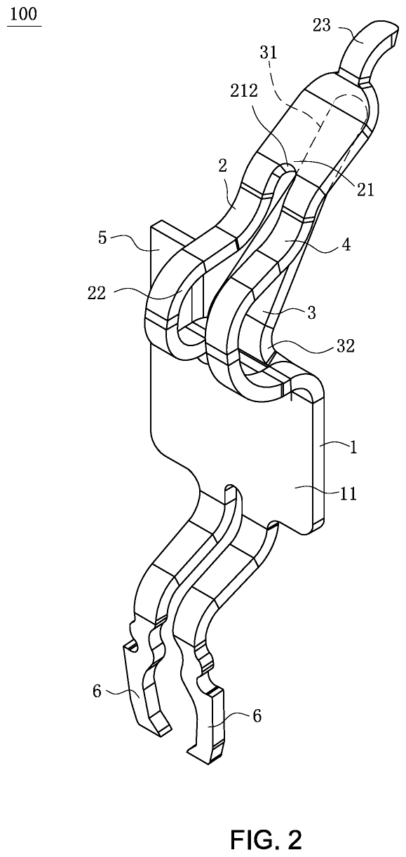

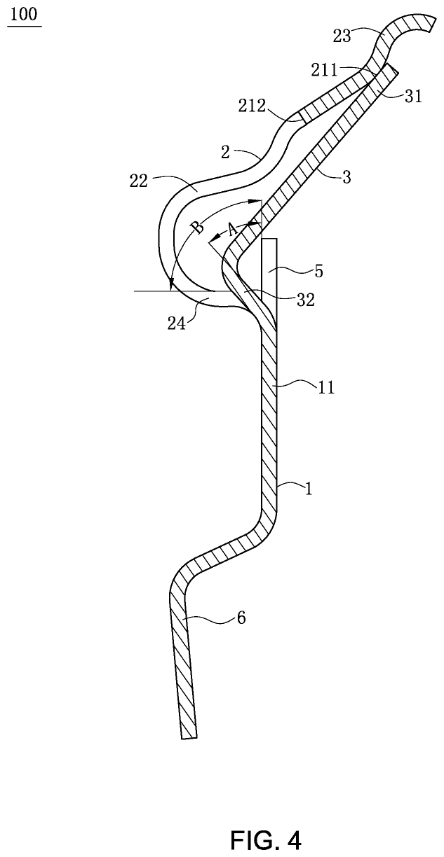

As shown in FIG. 2 and FIG. 4, the first elastic arm 2 extends upward from the upper end of the base 1 toward a direction away from the vertical plain surface 11, and bends and extends reversely to cross the vertical plain surface 11. A first torn surface 22 is provided on the first side of the first elastic arm 2. A protruding portion 21 laterally protrudes and extends from the first torn surface 22, and the protruding portion 21 has a cutting surface 212 connected to the first torn surface 22. A lower surface of the protruding portion 21 has a contact surface 211, and the contact surface 211 is an arc surface. A top portion of the first elastic arm 2 is provided with a mating portion 23 to upward abut the chip module, and the mating portion 23 is connected to the contact surface 211. The first elastic arm 2 has a connecting portion 24 connected to the upper end of the base 1, and the connecting portion 24 and the protruding portion 21 are located at two opposite sides of the base 1.

As shown in FIG. 2 to FIG. 4, the third elastic arm 4 bends and extends from the upper end of the base 1 to the protruding portion 21. A second torn surface 41 is provided on one side of the third elastic arm 4 adjacent to the second elastic arm 3. The third elastic arm 4 and the first elastic arm 2 are provided in parallel, and the structure of the first elastic arm 2 from the protruding portion 21 to the upper end of the base 1 is the identical to that of the third elastic arm 4.

As shown in FIG. 2 to FIG. 4, a junction between the second elastic arm 3 and the base 1 and a junction between the first elastic arm 2 and the base 1 are provided side by side. The second elastic arm 3 extends upward from the upper end of the base 1 toward a direction away from the vertical plain surface 11, and bends and extends reversely direction to cross the vertical plain surface 11. A width of the second elastic arm 3 gradually decreases along a upward-from-bottom direction. The second elastic arm 3 has a contact portion 31, and the contact portion 31 is flat plate shaped. The contact portion 31 and the contact surface 211 overlap with each other vertically, and the contact portion 31 upward abuts the contact surface 211. When the chip module presses downward on the mating portion 23, the contact portion 31 can move on the contact surface 211. Therefore, the chip module does not need to press downward on the mating portion 23 with a relatively large pressure. The second elastic arm 3 is connected to the cutting surface 212 before being formed (as shown in FIG. 1). During forming, a tail end of the second elastic arm 3 is cut off from the cutting surface 212, and two opposite sides of the second elastic arm 3 are formed by tearing from the first torn surface 22 and the second torn surface 41, such that the width of the second elastic arm 3 is equal to a gap width between the first elastic arm 2 and the third elastic arm 4, and a length of the second elastic arm 3 is equal to a length of the first elastic arm 2 from the cutting surface 212 to the upper end of the base 1. In another embodiment, the tail end of the second elastic arm 3 can be cut off from the protruding portion 21 through blanking, and therefore, the length of the first elastic arm 2 from the cutting surface 212 to the upper end of the base 1 is greater than the length of the second elastic arm 3. The second elastic arm 3 has an extending portion 32 connected to the upper end of the base 1. The extending portion 32 and the contact portion 31 are located at two opposite sides of the base 1, and the connecting portion 24 and the extending portion 32 are located at a same side of the base 1. A bending angle A of the extending portion 32 relative to the base 1 is smaller than a bending angle B of the connecting portion 24 relative to the base 1.

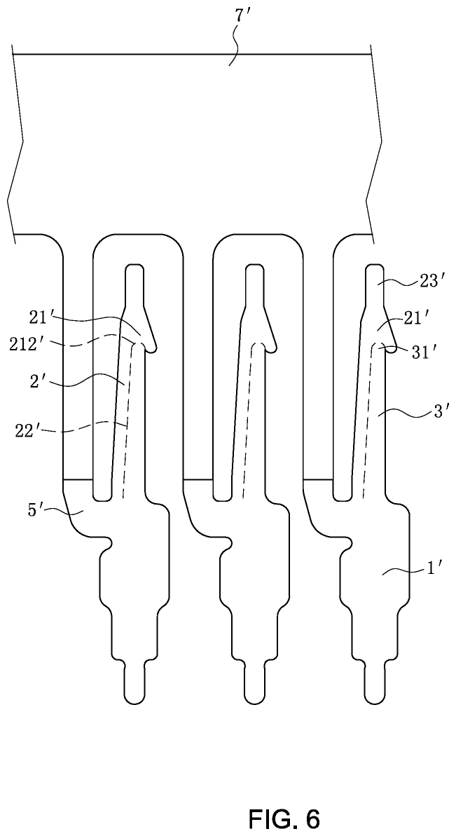

FIG. 6 to FIG. 10 show a terminal 100 according to a second embodiment of the present invention. The terminal 100 is used to electrically connect a chip module (not shown) and a circuit board (not shown). The terminal 100 is formed by stamping a metal plate. Each terminal 100 includes a base 1′ that is vertically flat plate shaped, and the base 1′ has a vertical plain surface 11′. A first elastic arm 2′ and a second elastic arm 3′ are formed by bending and extending upward from an upper end of the base 1′. The first elastic arm 2′ has a first side and a second side, where the first side of the first elastic arm 2′ is adjacent to the second elastic arm 3′, and the second side of the first elastic arm 2′ is located away from the second elastic arm 3′. A strip connecting portion 5′ is formed by bending from one side of the base 1′ to be connected to a strip 7′, and the strip connecting portion 5′ is located at the second side of the first elastic arm 2′. A first clamping arm 61 is formed by tearing, bending, and extending from a center of a lower end of the base 1′ to one side, such that a second clamping arm 62 is formed at each of two opposite sides of the first clamping arm 61. The first clamping arm 61 and the two second clamping arms 62 jointly clamp a solder ball (not shown) to be soldered to the circuit board.

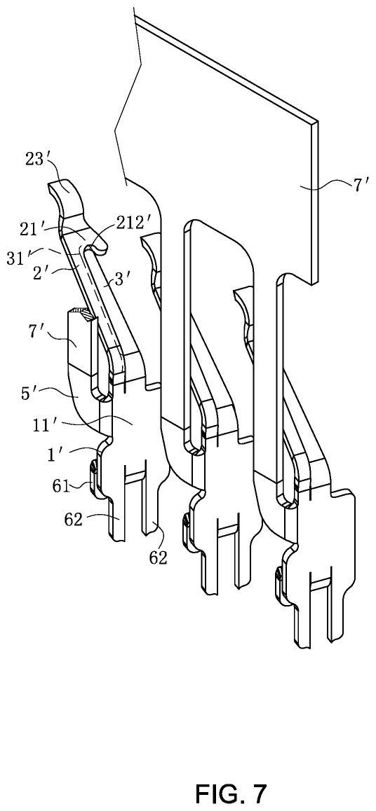

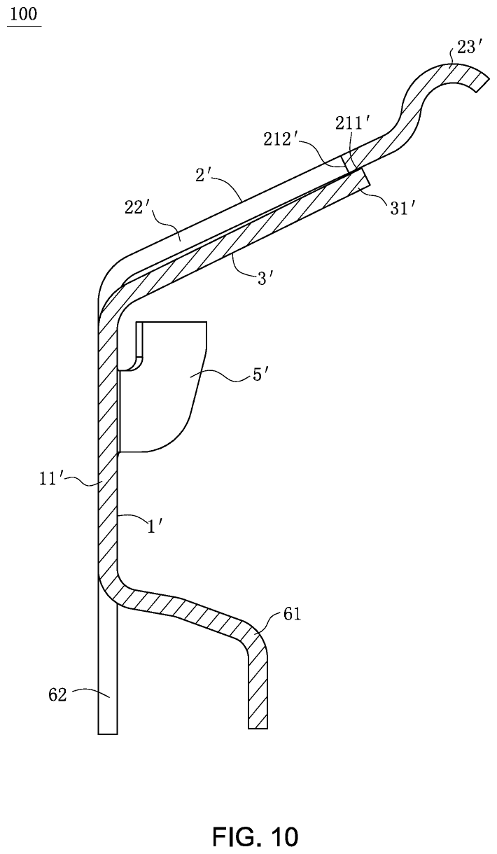

As shown in FIG. 7 to FIG. 9, the first elastic arm 2′ bends and extends from the upper end of the base 1′ to one side of the vertical plain surface 11′. A torn surface 22′ is provided on the first side of the first elastic arm 2′. A protruding portion 21′ laterally protrudes and extends from the torn surface 22′, and the protruding portion 21′ has a cutting surface 212′ connected to the torn surface 22′. A length of the first elastic arm 2′ from the cutting surface 212′ to the upper end of the base 1′ is greater than or equal to a length of the second elastic arm 3′. A lower surface of the protruding portion 21′ has a contact surface 211′ (as shown in FIG. 10). A top portion of the first elastic arm 2′ is provided with a mating portion 23′ to upward abut the chip module.

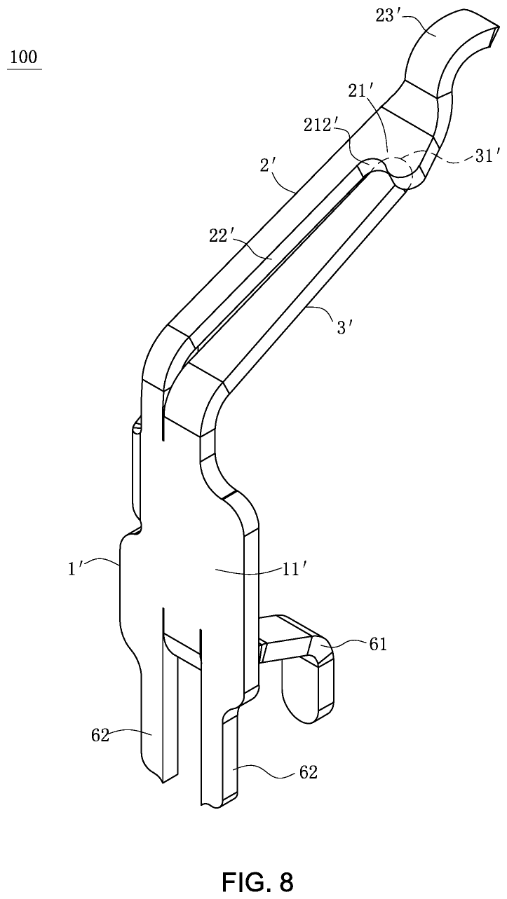

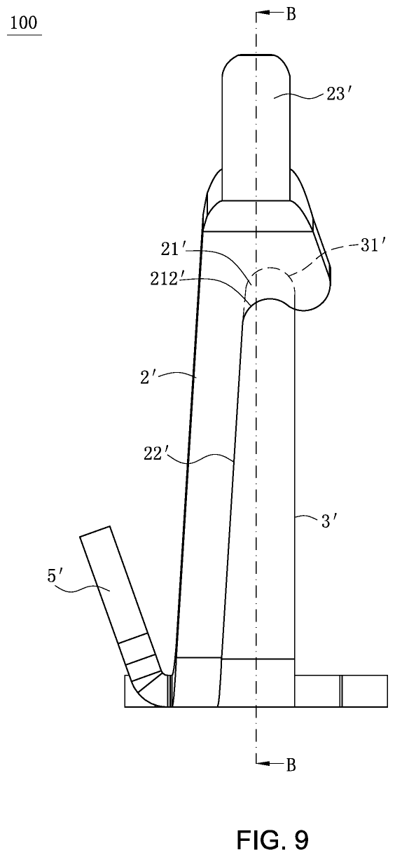

As shown in FIG. 8 and FIG. 9, a junction between the second elastic arm 3′ and the base 1′ and a junction between the first elastic arm 2′ and the base 1′ are provided side by side. The second elastic arm 3′ bends and extends from the upper end of the base 1′ to one side of the vertical plain surface 11′. A bending angle of the second elastic arm 3′ relative to the base 1′ is smaller than a bending angle of the first elastic arm 2′ relative to the base 1′. The second elastic arm 3′ has a contact portion 31′, and the contact portion 31′ is flat plate shaped. The contact portion 31′ and the contact surface 211′ overlap in a vertical direction, and the contact portion 31′ upward abuts the contact surface 211′. When the chip module presses downward on the mating portion 23′, the contact portion 31′ can move on the contact surface 211′. Therefore, the chip module does not need to press downward on the mating portion 23′ with a relatively large pressure. The second elastic arm 3′ is connected to the cutting surface 212′ before being formed (as shown in FIG. 6). During forming, a tail end of the second elastic arm 3′ is cut off from the cutting surface 212′, and the second elastic arm 3′ is formed at one side adjacent to the first elastic arm 2′ by slitting from the torn surface 22′.

To sum up, the terminal 100 according to certain embodiments of the present invention has the following beneficial effects:

(1) The protruding portion 21 protrudes and extends from the side of the first elastic arm 2 adjacent to the second elastic arm 3. The lower surface of the protruding portion 21 has the contact surface 211 overlapping the contact portion 31 in the vertical direction. The contact portion 31 upward abuts the contact surface 211. When the chip module presses downward on the terminal 100, the contact portion 31 can move on the contact surface 211. Therefore, the chip module does not need to press downward on the mating portion 23 with a relative large pressure.

(2) The second elastic arm 3 is firstly cut off from the protruding portion 21, and then formed by tearing from the first torn surface 22 and the second torn surface 41. That is, compared with the related art, the second elastic arm 3 uses a material for forming the through groove in the related art, thereby reducing material wastes and costs. In addition, widths of the first elastic arm 2 and the third elastic arm 4 are made relatively large when the materials are the same and the width of the second elastic arm 3 remains unchanged, thereby improving high-frequency performance of the terminal 100.

(3) Due to the existence of the first elastic arm 2, the second elastic arm 3, and the third elastic arm 4, a first conductive path sequentially passing through the mating portion 23, the first elastic arm 2, and the base 1, a second conductive path sequentially passing through the mating portion 23, the second elastic arm 3, and the base 1, and a third conductive path sequentially passing through the mating portion 23, the third elastic arm 4, and the base 1 are formed between the chip module and the circuit board. The three conductive paths are connected in parallel to one another, reducing impedance during telecommunication transmission between the chip module and the circuit board, thereby improving high-frequency performance.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A terminal, comprising:
a base;
a first elastic arm and a second elastic arm formed side by side by extending upward from an upper end of the base, wherein the first elastic arm has a mating portion, and the second elastic arm has a contact portion; and
a protruding portion, protruding and extending from a first side of the first elastic arm, wherein the first side of the first elastic arm is adjacent to the second elastic arm, and a lower surface of the protruding portion has a contact surface overlapping with the contact portion in a vertical direction, such that the contact portion upward abuts the contact surface.

2. The terminal according to claim 1, wherein the protruding portion has a cutting surface, a length of the first elastic arm from the cutting surface to the upper end of the base is greater than or equal to a length of the second elastic arm, and the second elastic arm is connected to the cutting surface before being formed and is cut off from the cutting surface after being formed.

3. The terminal according to claim 1, wherein a first torn surface is provided on the first side of the first elastic arm adjacent to the second elastic arm, and one of two sides of the second elastic arm is formed by tearing from the first torn surface.

4. The terminal according to claim 3, wherein a third elastic arm extends upward from the base to the protruding portion, the second elastic arm is located between the first elastic arm and the third elastic arm, a second torn surface is provided on one side of the third elastic arm adjacent to the second elastic arm, the other of the two sides of the second elastic arm is formed by tearing from the second torn surface, and the first elastic arm and the third elastic arm are provided in parallel.

5. The terminal according to claim 1, wherein a strip connecting portion is formed by extending from the base and is configured to be connected to a strip, the strip connecting portion is located at a second side of the first elastic arm, and the second side of the first elastic arm is located away from the second elastic arm.

6. The terminal according to claim 1, wherein the first elastic arm has a connecting portion connected to the upper end of the base, the connecting portion and the protruding portion are located at two opposite sides of the base, the second elastic arm has an extending portion connected to the upper end of the base, the extending portion and the contact portion are located at the two opposite sides of the base, and the connecting portion and the extending portion are located at a same side of the base.

7. The terminal according to claim 1, wherein the contact portion is flat plate shaped, and the contact surface is an arc surface.

8. A terminal, comprising:
a flat plate portion;
a first elastic arm, formed by bending and extending upward from an upper end of the flat plate portion, wherein a top portion of the first elastic arm has a mating portion, one side of the first elastic arm is provided with a torn surface, a protruding portion is formed by laterally extending from the torn surface, the protruding portion has a cutting surface connected to the torn surface, and a lower surface of the protruding portion has a contact surface; and
a second elastic arm, formed by bending and extending upward from the upper end of the flat plate portion, wherein a tail end of the second elastic arm is cut off from the cutting surface during forming, one of two sides of the second elastic arm is formed by tearing from the torn surface, and the second elastic arm has a contact portion overlapping with the contact surface in a vertical direction, such that the contact portion upward abuts the contact surface.

9. The terminal according to claim 8, wherein a third elastic arm extends upward from the flat plate portion to the protruding portion, the second elastic arm is located between the first elastic arm and the third elastic arm, the other of the two sides of the second elastic arm is formed by tearing from the third elastic arm, such that a width of the second elastic arm is equal to a gap width between the first elastic arm and the third elastic arm.

10. The terminal according to claim 8, wherein the first elastic arm has a connecting portion connected to the upper end of the flat plate portion, the connecting portion and the protruding portion are located at two opposite sides of the flat plate portion, the second elastic arm has an extending portion connected to the upper end of the flat plate portion, the extending portion and the contact portion are located at the two opposite sides of the flat plate portion, and the connecting portion and the extending portion are located at a same side of the flat plate portion.
